(19) United States
(12) Patent Application Publication
(10) Pub. No.: US 2008/0095235 A1
(43) Pub. Date: Apr. 24, 2008

(54) METHOD AND APPARATUS FOR INTRA-FRAME SPATIAL SCALABLE VIDEO CODING

(75) Inventor: Shih-Ta Hsiang, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/866,771

(22) Filed: Oct. 3, 2007

Related U.S. Application Data
(63) Continuation-in-part of application No. 60/862,284, filed on Oct. 20, 2006.

(51) Int. Cl. H04N 7/50

(52) U.S. Cl. 375/240.13; 375/E07.211

(57) ABSTRACT

An apparatus and method are for intra-frame spatial scalable video encoding. The method codes a low resolution base layer video bitstream from low resolution base layer video using a single layer encoder, and codes an enhancement layer in which individual videos frames are represented by wavelet coefficients for an LL residual sub-band, an HL sub-band, an LH sub-band; and an HH sub-band. The LL residual sub-band is generated as a difference of an LL sub-band and a recovered version of the base layer video bitstream.

### FIELD OF THE INVENTION

The present invention relates generally to video signal compression and more particularly to video signal compression for high definition video signals.

### BACKGROUND

In recent years, subband (and wavelet) coding has been demonstrated to be one of the most efficient methods for image coding in the literature. It has also been utilized in the international standard JPEG 2000 for image and video (in the format of Motion JPEG 2000) coding applications in industry. Thanks to high energy compaction of subband/wavelet transform, these state-of-the-art coders are capable of achieving excellent compression performance without traditional blocky artifacts associated with the block transform. More importantly, they can easily accommodate the desirable spatial scalable coding functionality with almost no penalty in compression efficiency because the subband/wavelet transform is resolution scalable by nature. FIG. 1 is a diagram that uses representations of the coded subbands to illustrate their relationship for an image that has been subband coded with three resolution levels, n=0, n=1, and n=2, in accordance with prior art practices. Higher resolution levels such as n=2 are synthesized from three subbands (commonly designate HL, LH, HH) at the higher level, plus the subbands from all the next lower levels, with an understanding that the “subband” of the lowest level is a base layer that provides a low resolution version of the image.

On the other hand, the former video coding standards such as MPEG-2/4 and H.263+ and the emerging MPEG-4 AVC/H.264 scalable video coding (SVC) amendment adopt a pyramidal approach to spatial scalable coding. This method utilizes the interpolated frame from the recovered base layer video to predict the related high-resolution frame at the enhancement layer and the resulting residual signal is coded by the enhancement layer bitstream. This is illustrated in FIG. 2, which is a diagram that uses representations of the coded intra-frame layers to illustrate their relationship for a video frame that has been scalably coded with three resolution levels, in accordance with prior art practices. Unlike wavelet/subband coding in which the low resolution signal determined by the lowpass filter of the selected analysis filter banks, the pyramidal coding scheme allows great flexibility for image down-sampler design. However, the number of source pixel samples is increased by 33.3% for building a complete image pyramidal representation in the resulting coding system, which can inherently reduce compression efficiency. The simulation results from the JVT core experiment also show that the MPEG-4 AVC/H.264 joint scalable video model (JSVM) current at the time of filing of this application suffers from substantial efficiency loss for intra dyadic spatial scalable coding, particularly toward the high bitrate range that is commonly adopted for intra-frame video applications. In this system, the levels n=1, n=2 are called enhancement layers and the layer n=0 is a base layer which provides a lowest resolution version of a video frame.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates the signal representation of a coded image or video frame using a subband/wavelet coding approach with three resolution levels in accordance with prior art practices.

FIG. 2 illustrates the signal representation of a coded image or video frame using a pyramidal coding approach with three resolution levels in accordance with prior art practices.

FIG. 3 shows a high level block diagram of a general spatial scalable encoding system with three resolution scalable layers.

FIG. 4 shows a high level block diagram of a general spatial scalable decoding system with two resolution scalable layers.

FIG. 5 shows a block diagram of the proposed spatial scalable encoding system for certain embodiments having two layers of resolution, in accordance with certain embodiments.

FIG. 6 shows a block diagram of the proposed spatial scalable decoding system for certain embodiments having two layers of resolution.

FIG. 7 shows a block diagram for 2-D down sampling operation, in accordance with certain 2-D separable dyadic embodiments.

FIG. 8 is a block diagram that illustrates certain subband analysis filter banks, in accordance with certain 2-D separable dyadic embodiments.

FIG. 9 illustrates the subband partition for a decomposed frame after two levels of the dyadic subband decomposition, in accordance with certain embodiments.

FIG. 10 is a flow chart that shows some steps of a spatial scalable video encoding method for compressing a source video frame, in accordance with certain embodiments

FIG. 11 is a flow chart that shows some steps of a spatial scalable video decoding method for decompressing a coded video frame, in accordance with certain embodiments

FIG. 12 is a block diagram of an intra-layer frame texture encoder, in accordance with certain embodiments.

FIG. 13 is a block diagram of an intra-layer frame texture decoder, in accordance with certain embodiments.

FIG. 14 is a block diagram of an inter-layer frame texture encoder, in accordance with certain embodiments.

FIG. 15 is a block diagram of an inter-layer frame texture decoder, in accordance with certain embodiments.

FIG. 16 is a block diagram of another inter-layer frame texture encoder, in accordance with certain embodiments.

FIG. 17 is a block diagram of another inter-layer frame texture decoder, in accordance with certain embodiments.

FIG. 18 illustrates the signal representation of a coded image or video frame using the proposed new subband/wavelet coding approach with three resolution levels, in accordance with certain embodiments

FIGS. 19-21 are graphs of simulations that compare the performance of certain embodiments with performance of prior art systems.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the following embodiments, it should be observed that the embodiments reside primarily in combinations of method steps and apparatus components related to intra-frame spatial and scalable video encoding. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Referring to FIG. 3, a high level block diagram is presented that shows a spatial scalable encoding system 400 for conventional systems and for certain embodiments having three layers of resolution, which is used to provide an introduction to the general spatial scalable encoding system architecture. A video frame signal 401 for a highest resolution version of a video frame is coupled to two dimensional (2-D) down sampler 404 and to an enhancement layer encoder 450. The 2-D down sampler generates a down sampled version 402 of the video frame that is coupled to a 2 dimensional down sampler 405 and to an enhancement layer encoder 430. The 2 dimensional down sampler 405, which may be different from the 2 dimensional down sampler 404, generates a lowest resolution version of the video frame that is coupled to a base layer encoder 410. The base layer encoder 410 generates a base layer bitstream 415 as an output that is coupled to a multiplexer 420. The enhancement layer encoder 430 uses recovered information 435 from the base layer for removing interlayer redundancies and generates an enhancement layer bitstream 438 as an output for representing the coded input video frame 402. The enhancement layer bitstream 438 is also coupled to the multiplexer 420. The enhancement layer encoder 450 uses recovered information 445 from the next lower layer for removing interlayer redundancies and generates an enhancement layer bitstream 455 as an output for representing the coded input video frame 401. The enhancement layer bitstream 455 is also coupled to the multiplexer 420. The multiplexer 420 multiplexes the base layer bitstream and the two enhancement layer bitstreams 438, 455 to generate a scalable bitstream 440 that conveys the encoded information needed to recover either a low resolution version of the video frame, a higher resolution version of the video frame, or a highest resolution version of the bitstream.

Referring to FIG. 4, a high level block diagram is presented that shows a spatial scalable decoding system 500 for conventional systems and for certain embodiments having two layers of resolution, which is used to provide an introduction to the general spatial scalable decoding system architecture. It will be appreciated that this high level block diagram closely mirrors the high level block diagram of the encoder 400. A demultiplexer 510 demultiplexes a received version 505 of the scalable bitstream 440 into a received base layer bitstream 515 and a received enhancement layer bitstream 520. A base layer decoder 525 decodes the received base layer bitstream 515 and generates a recovered low resolution version 530 of the original video frame. An enhancement layer decoder 540 decodes the received enhancement layer bitstream 520 and further uses recovered information 535 from the base layer to generate a recovered high resolution version 545 of the coded video frame. It should be apparent to one of ordinary skill in the art how the high level block diagram for an embodiment having three layers of resolution would be constructed.

The proposed techniques described herein introduce a new intra-frame spatial scalable coding framework based on a subband/wavelet coding approach. In the proposed techniques, the employed down-sampling filters for generating low resolution video at the lower resolution layers are not particularly tied to a specific subband/wavelet filter selection for signal representation, in a clear contrast to a conventional wavelet coding system. In addition, our research efforts have been further aimed at efficiently exploiting the subband/wavelet techniques within the traditional macroblock and DCT (discrete cosine transform) based video coding system for improved efficiency of intra-frame spatial scalable coding. Unlike the former MPEG-4 visual texture coding (VTC) which is practically built upon a separate zero-tree based system for coding wavelet coefficients, the framework of the subband coding embodiments has been integrated with the H.264 JSVM reference software with little modifications to the current standard. As such, the modified H.264 coding system can take advantage of the benefits of wavelet coding without much increase in implementation complexity.

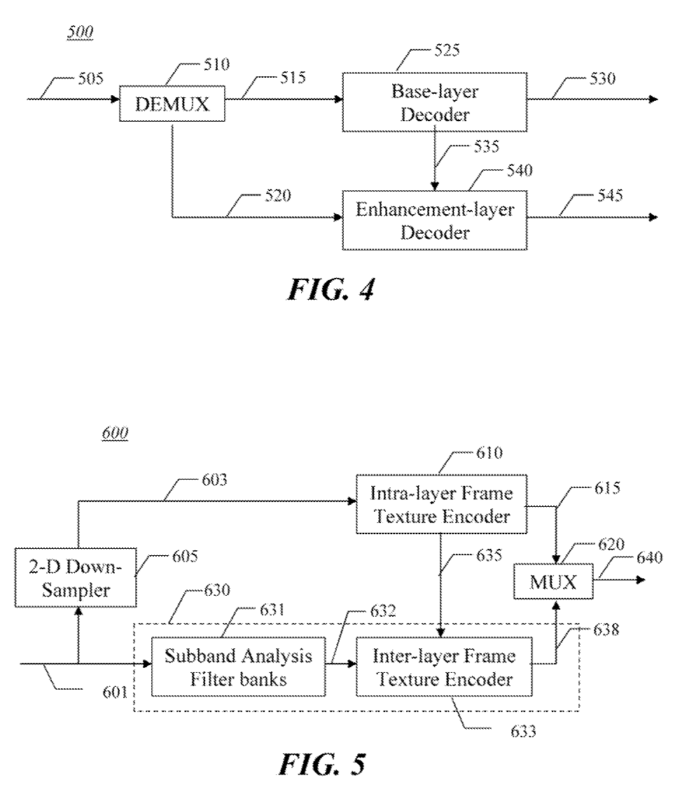

Referring to FIG. 5, a block diagram shows a spatial scalable encoding system 600 for certain of the proposed embodiments having two layers of resolution. A video frame signal 601 for a highest resolution version of a video frame is coupled to a two dimensional (2-D) down sampler 605 and to subband analysis filter banks 631 of an enhancement layer encoder 630. The 2-D down sampler 605 generates a lowest resolution version 603 of the source video frame. The lowest resolution version 603 is coupled to a base layer encoder that comprises an intra-layer frame texture encoder 610. The intra-layer frame texture encoder 610 generates a base layer bitstream 615 as an output that is coupled to a multiplexer 620. The subband analysis filter banks 631 generate subband (wavelet) coefficients of the highest resolution version 601 of the video frame—these are usually the subbands referred in the art as the LL, LH, HL, and HH subbands. The inter-layer frame texture encoder 633 utilizes information 635 from the base layer for removing interlayer redundancies and generates an enhancement layer bitstream 438 as an output for representing the coded input subband representation 632. The enhancement layer bitstream 438 is also coupled to the multiplexer 620. The multiplexer 620 multiplexes the base layer bitstream 615 and the enhancement layer bitstream 438 to generate a scalable bitstream 640 that conveys the encoded information needed to recover either a low resolution version of the video frame or a highest resolution version of the bitstream. It will be appreciated that in an embodiment having more enhancement layers, the subband analysis filter banks of each enhancement layer encoder are applied to generate a subband representation for a particular resolution version of a source video frame and the resulting subband coefficients of the representations are encoded by the inter-layer texture frame encoder at each enhancement layer.

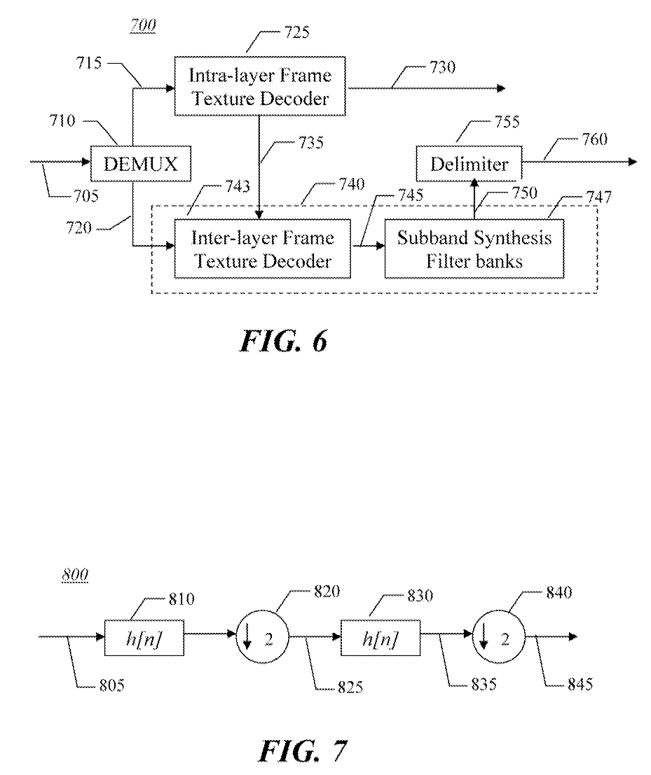

Referring to FIG. 6, a block diagram shows a spatial scalable decoding system 700 for certain embodiments having two layers of resolution. It will be appreciated that this block diagram closely mirrors the block diagram of the encoder 600. A demultiplexer 710 demultiplexes a received version 705 of the scalable bitstream 440 into a received base layer bitstream 715 and a received enhancement layer bitstream 720. The received base layer bitstream 715 is decoded by a base layer decoder that comprises an intra-layer frame texture decoder 725 and generates a recovered low resolution version 730 of the coded video frame. The inter-layer frame texture decoder 743 decodes the received enhancement layer bitstream 720 and further uses recovered information 735 from the base layer to generate a recovered subband representation 745 of the enhancement layer. Subband synthesis filters banks 747 then process the recovered subband representation 745 and generate a synthesized high resolution version 750 of the coded video frame. The synthesized high resolution version 750 of the coded video frame is finally coupled to a delimiter 755 that performs a clipping operation on the synthesized frame according to the pixel value range. It should be apparent to one of ordinary skill in the art how the lower level block diagram for an embodiment having three or more layers of resolution would be constructed.

Referring to FIG. 7, a block diagram illustrates the down sampling operation performed by the 2-D down-sampler 404, 405, and 605, in accordance with certain 2-D separable dyadic embodiments. The video frame information 810 (also referred to more simply as the video frame) is accepted as an input by a first one dimensional (1-D) filter 810 which performs vertical filtering on the individual columns of the input video frame and the filtered frame is then further down sampled vertically by a factor of 2. This result 825 is next processed by a second 1-D filter 830 which performs horizontal filtering on the individual rows of the input signal 825 and the filtered signal is then further down sampled horizontally by a factor of 2, creating a low resolution version of the input frame 845 with down scaled size by a factor of 2 in each spatial dimension. Typically, the same 1-D low-pass filter is employed by both filters 810 and 830. In certain embodiments, the down sampling operation as just described is used to create the versions of the source video frame other than the version of the source video frame having the highest resolution by starting with the highest resolution version of the source video frame and recursively creating each next lower resolution source video frame from a current version by performing a cascaded two-dimensional (2-D) separable filtering and down-sampling operation that uses a one-dimensional lowpass filter associated with each version. In certain embodiments, each lowpass filter may be one of an MPEG-2 decimation filter for 2-D separable filtering with the filter coefficients (−29, 0, 88, 138, 88, 0, −29)/256, an MPEG-4 decimation filter with the filter coefficients (2, 0, −4, −3, 5, 19, 26, 19, 5, −3, −4, 0, 2)/64, as described in versions of the named documents on or before 20 Oct. 2006. In certain alternative embodiments, each lowpass filter is a low pass filter of the subband analysis filter banks with the values of filter coefficients further scaled by a scaling factor. In these embodiments, the low pass filter used to generate the lowest resolution version of the video frame may be different from layer to layer and may be done directly from the highest resolution version of the video frame. This unique feature provides the flexibility for down-sampler design to create optimal low resolution versions of the video frame.

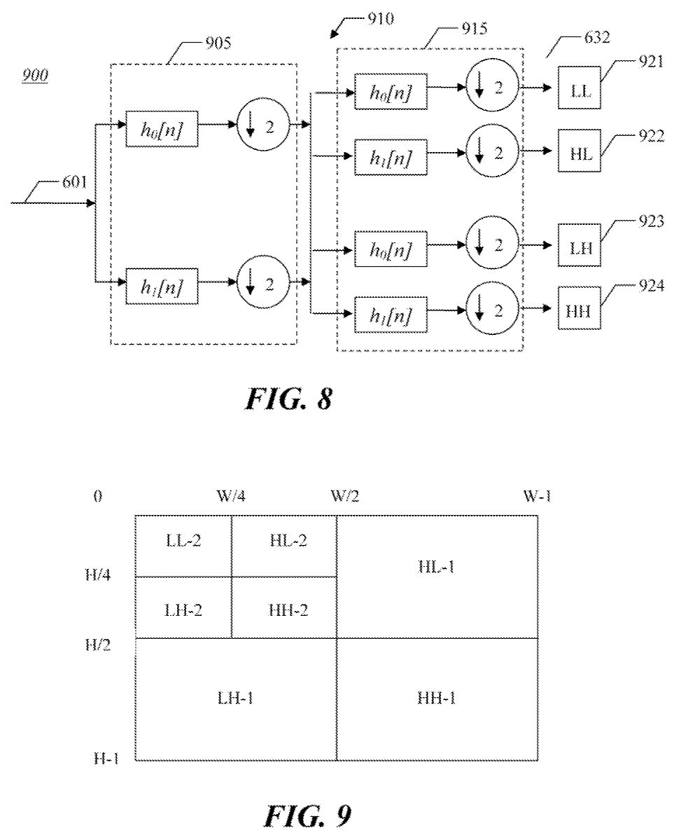

Referring to FIG. 8, a block diagram illustrates the subband analysis filter banks 631 (FIG. 5), in accordance with certain 2-D separable dyadic embodiments. An input video frame is first respectively processed by a lowpass filter and a highpass filter followed by a down sampling operation along the vertical direction, generating intermediate signals 910. The intermediate signals 910 are then respectively processed by a lowpass filter and a highpass filter followed by a down sampling operation along the horizontal direction, generating the four subbands (LL 921, HL 922, LH 923, and HH 924) for the version of the video frame at the particular resolution. This process is commonly referred to as wavelet/subband decomposition. The subband synthesis filter banks are a mirror version of the corresponding subband analysis filter banks. The filters used in the subband analysis/synthesis filter banks may belong to a family of wavelet filters or a family of QMF filters. For a system that has a plurality of levels of resolution, each set of subbands for representing the current resolution level can be synthesized to form the LL subband of the next higher level of resolution. This aspect is illustrated by FIG. 9, in which the subbands of the highest resolution layer are indicated by the suffix −1, and in which the base or lowest layer is LL-2. H and W stand for, respectively, for height and width of the full resolution video frame.

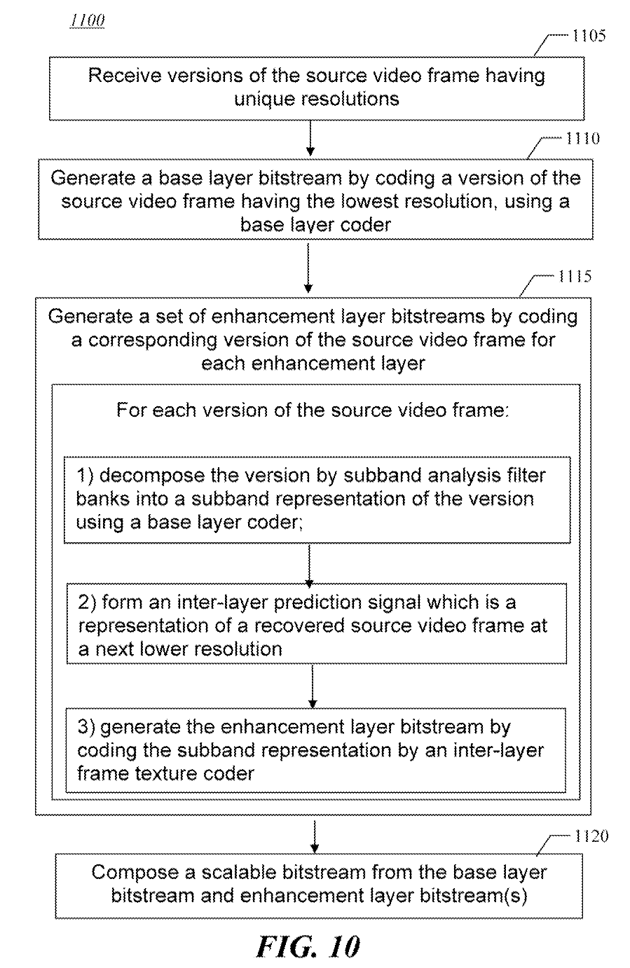

Referring to FIG. 10, a flow chart 1100 shows some steps of a spatial scalable video encoding method for compressing a source video frame, in accordance with certain embodiments, based at least in part on the descriptions above with reference to FIGS. 3-9. The method 1100 is generalized for a video frame that uses any number of versions of the video frame, wherein each version has a unique resolution. At step 1105, versions of a source video frame are received, in which each version has a unique resolution. A base layer bitstream is generated at step 1110 by encoding a version of the source video frame having the lowest resolution, using a base layer encoder. A set of enhancement layer bitstreams is generated at step 1115, in which each enhancement layer bitstream in the set is generated by encoding a corresponding one of the versions of the source video frame. There may be as few as one enhancement layer bitstream in the set. For each version of the source video frame, the encoding comprises 1) decomposing the corresponding one of the versions of the source video frame by subband analysis filter banks into a subband representation of the corresponding one of the versions of the source video frame, 2) forming an inter-layer prediction signal which is a representation of a recovered source video frame at a next lower resolution; and 3) generating the enhancement layer bitstream by encoding the subband representation by an inter-layer frame texture encoder that uses the inter-layer prediction signal. A scalable bitstream is composed at step 1120 from the base layer bitstream and the set of enhancement layer bitstreams using a bitstream multiplexer.

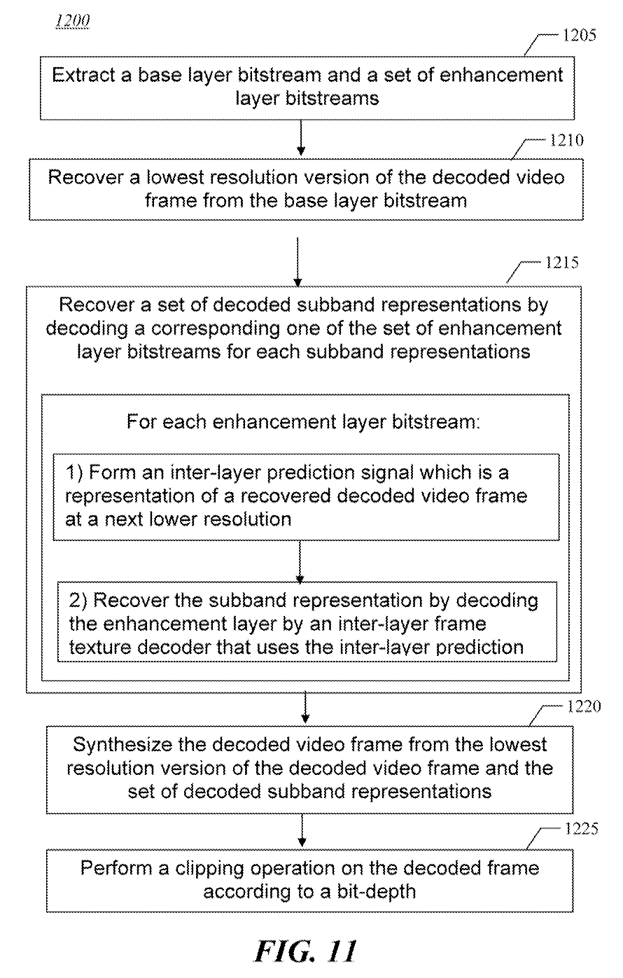

Referring to FIG. 11, a flow chart 1200 shows some steps of a spatial scalable video decoding method for decompressing a coded video frame into a decoded video frame, in accordance with certain embodiments, based at least in part on the descriptions above with reference to FIGS. 3-9. At step 1205, a base layer bitstream and a set of enhancement layer bitstreams are extracted using a bitstream de-multiplexer. At step 1210, a lowest resolution version of the decoded video frame is recovered from the base layer bitstream using a base layer decoder. At step 1215, a set of decoded subband representations is recovered. Each decoded subband representation in the set is recovered by decoding a corresponding one of the set of enhancement layer bitstreams. For each enhancement layer bitstream, the decoding comprises 1) forming an inter-layer prediction signal which is a representation of a recovered decoded video frame at a next lower resolution, and 2) recovering the subband representation by decoding the enhancement layer by an inter-layer frame texture decoder that uses the inter-layer prediction signal. The decoded video frame is synthesized from the lowest resolution version of the decoded video frame and the set of decoded subband representations using subband synthesis filter banks. At step 1225, a clipping operation may be performed on the decoded frame according to the pixel value range adopted for the pixel representation.

It will be appreciated that, while the methods 1100 and 1200 are described in terms of encoding and decoding a video frame, the same methods apply to encoding and decoding an image that is not part of a video sequence.

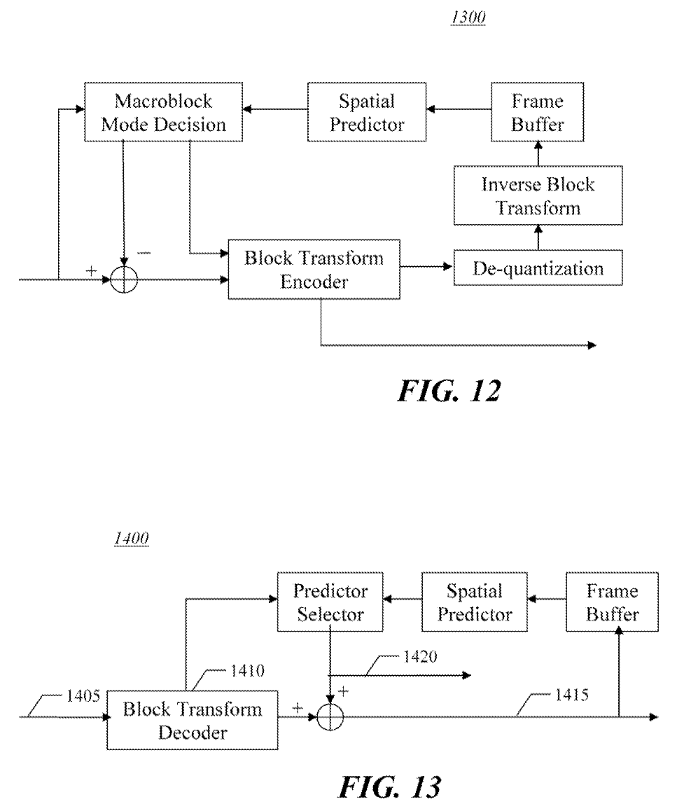

The base layer video 603 in the proposed spatial scalable encoding system 600 can be encoded by a conventional single layer intra-frame video encoder, wherein each video frame is encoded by a conventional intra-layer frame texture encoder. Referring to FIG. 12, a block diagram of an intra-layer frame texture encoder 1300 is shown, in accordance with certain embodiments. The intra-layer frame texture encoder 1300 is an example that could be used for the intra-layer frame texture encoder 610 (FIG. 5) in the spatial scalable encoding system 600 (FIG. 5). The intra-layer frame texture encoder 1300 comprises conventional functional blocks that are inter-coupled in a conventional manner, and in particular uses a conventional block transform encoder 1310 to perform macroblock encoding of an input signal 1305 to generate an output signal 1315 and an inter-layer prediction signal 1320. When the input signal is a lowest resolution version of the source video frame, as it is in the embodiment of FIG. 5, the output signal is an encoded base layer bitstream.

Referring to FIG. 13, a block diagram of an intra-layer frame texture decoder 1400 is shown, in accordance with certain embodiments. The intra-layer frame texture decoder 1400 is an example that could be used for the intra-layer frame texture decoder 725 (FIG. 6) in the spatial scalable decoding system 700 (FIG. 6). The intra-layer frame texture decoder 1400 comprises conventional functional blocks that are inter-coupled in a conventional manner, and in particular uses a conventional block transform decoder 1410 to perform macroblock decoding of an input signal 1405 to generate an output signal 1415

It is a desirable feature that the base layer bitstream from a scalable coding system is compatible with a non-scalable bitstream from a conventional single layer coding system. In certain embodiments, the intra-layer frame texture decoder 1400 is an intra-frame decoder described in the versions of the standards MPEG-1, MPEG-2, MPEG-4, H.261, H.263, MPEG-4 AVC/H.264 and JPEG as published on or before 20 Oct. 2006).

Various methods for compressing subband/wavelet coefficients of a transformed image have been presented in the literature. For example, a zero-tree based algorithm is utilized by the MPEG-4 wavelet visual texture coding (VTC) tool (as published on or before 20 Oct. 2006). JPEG2000 adopted the EBCOT algorithm (the version published on or before 20 Oct. 2006) which is a multi-pass context-adaptive coding scheme for encoding individual wavelet coefficient bit-planes. A unique and beneficial aspect of our certain embodiments is to effectively exploit the conventional video tools for efficient implementation of the proposed subband/wavelet scalable coding system. Particularly, the DCT macroblock coding tools designed for coding pixel samples in the current video coding standards are employed to encode subband/wavelet coefficients in these embodiments. In this way, the proposed scalable coding techniques can be implemented with low cost by most re-use of the existing video tools.

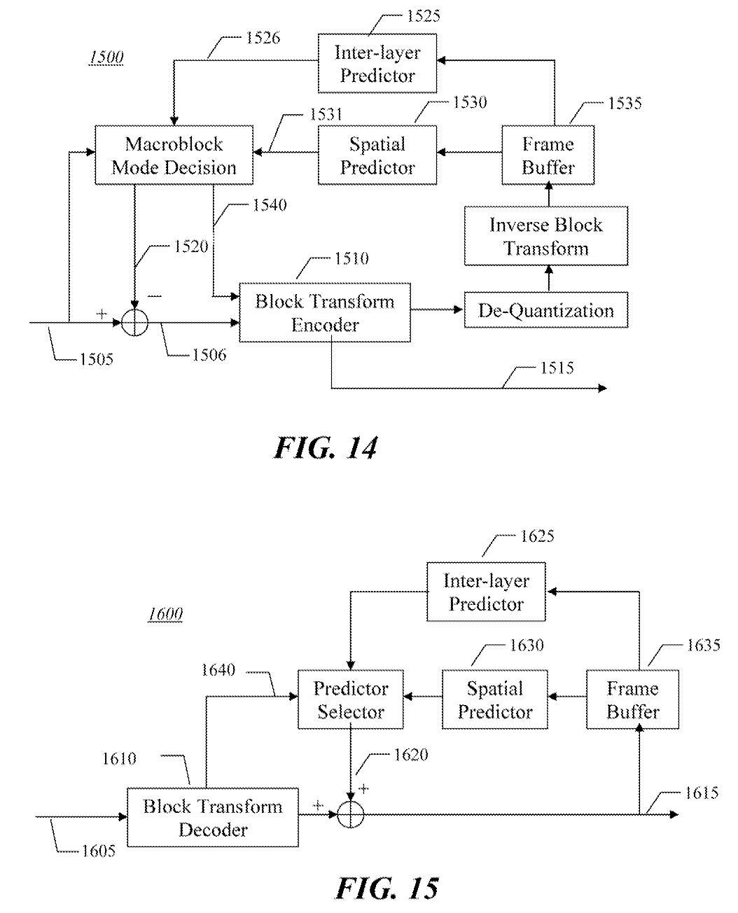

Referring to FIG. 14, a block diagram of an inter-layer frame texture encoder 1500 is shown, in accordance with certain embodiments. The inter-layer frame texture encoder 1500 is an example that could be used for encoding an enhancement layer frame in a conventional scalable video encoding system. It is used as the inter-layer frame texture encoder 633 (FIG. 5) for encoding an enhancement layer subband decomposed frame in certain embodiments of the proposed spatial scalable encoding system 600 (FIG. 5). The inter-layer frame texture encoder 1500 comprises conventional functional blocks—in particular a conventional block transform encoder 1510—to perform macroblock encoding of an input signal 1505 to generate an output signal 1515. The input signal 1505 is typically a subband representation of a version of the source frame having a resolution other than the lowest resolution, such as the subband representation 632 of the full resolution signal 601 in the spatial scalable encoding system 600. The subband representation is sequentially partitioned into a plurality of block subband representations for non-overlapped blocks, further comprising encoding the block subband representation for each non-overlapped block by the inter-layer frame texture encoder. The blocks may be those blocks commonly referred to as macroblocks. The output signal 1515 is an enhancement layer bitstream comprising block encoded prediction error of the subband representation 632 and 1505. The block encoded prediction error may be formed by block encoding a difference of the subband representation at the input 1505 to the inter-layer frame texture encoder 1500 and a prediction signal 1520 that is selected from one of an inter-layer predictor 1525 and a spatial predictor 1530 on a block by block basis, using a frame buffer 1535 to store a frame that is being reconstructed during the encoding process on a block basis. The type of prediction signal that has been selected for each block is indicated by a mode identifier 1540 in a syntax element of the bitstream 1515. In certain of these embodiments, the inter-layer prediction signal 1526 is set to zero for the highest frequency subbands

Referring to FIG. 15, a block diagram of an inter-layer frame texture decoder 1600 is shown, in accordance with certain embodiments. The inter-layer frame texture decoder 1600 is an example that could be used for the inter-layer frame texture decoder 743 (FIG. 6) in the spatial scalable decoding system 700 (FIG. 6). The inter-layer frame texture decoder 1600 comprises conventional functional blocks—in particular a conventional block transform decoder 1610—to perform macroblock decoding of an input signal 1605 to generate an output signal 1615. The input signal 1605 is typically an enhancement layer bitstream 1515 as described above with reference to FIG. 14. The bitstream is applied to a block transform decoder 1610, which generates block decoded prediction error of the subband representation. The blocks may be those blocks commonly referred to as macroblocks. Using a mode indication 1640 obtained form a syntax element of the bitstream, the inter-layer frame texture decoder 1600 adaptively generating a prediction signal 1620 of the subband representation on a block by block basis by one of an inter-layer predictor 1625 and a spatial predictor 1630. The prediction signal is added to the subband prediction error on a block basis to generate a decoded subband representation of a version of the source frame having a resolution other than the lowest resolution. In certain of these embodiments, the inter-layer prediction signal is set to zero for the highest frequency subbands

In certain of these embodiments, the inter-layer frame texture encoder 1600 comprises an enhancement layer intra-frame decoder described in one of the standards MPEG-2, MPEG-4, the version.2 of H.263, and Amendment 3 (Scalable Video Extension) of the MPEG-4 Part 10 AVC/H.264 but without the clipping operation performed on the decoded signal in the intra-frame encoder. In certain of these embodiments, the set of enhancement layer bitstreams is compatible with Amendment 3 (Scalable Video Extension) of the MPEG-4 Part 10 AVC/H.264 standard.

Referring to FIG. 16, a block diagram shows another inter-layer frame texture encoder 1700, in accordance with certain embodiments. In comparison to the inter-layer frame texture encoder 1500, the intra-layer frame texture encoder 1300 (FIG. 12), which is more widely available for conventional video coding applications, is utilized to build an inter-layer frame texture encoder. In these embodiments, the intra-layer frame texture encoder 1300 encodes a residual (prediction error) signal 1725 that is a difference between the subband representation 1705 and the inter-layer prediction signal 1720 to generate an output bitstream 1715

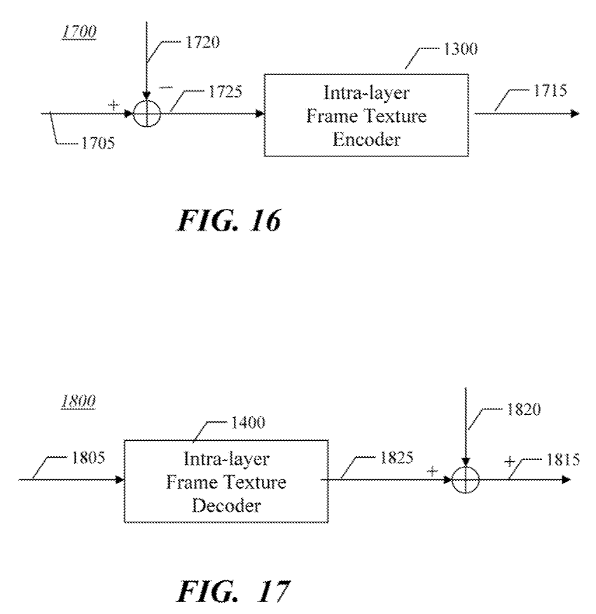

Referring to FIG. 17, a block diagram shows an inter-layer frame texture decoder 1800, in accordance with certain embodiments. The inter-layer frame texture decoder 1800 has an architecture that mirrors inter-layer frame texture encoder 1700. The inter-layer texture decoder 1800 comprises an intra-layer texture decoder 1400 (FIG. 13) that generates a residual signal 1825 (prediction error) from an enhancement layer 1805 and the subband representation 1815 is generated by adding the inter-layer prediction signal 1820 to the residual signal 1825.

In certain embodiments, the enhancement layer bitstreams contain a syntax element indicating the number of the subband decomposition levels for representing an enhancement layer video frame. In this way the number of the subband levels can be individually optimized for each enhancement layer frame for best coding performance.

Referring to FIG. 18, a diagram uses representations of coded layers to illustrate their relationship for an example of a video frame that has been encoded with three spatial scalable layers, n=0, n=1, and n=2, in accordance with certain of the proposed embodiments. When the normalized subband low-pass analysis filter is adopted as the lowpass filter 800 (FIG. 7) for image down-sampling at the base layer as well as for the analysis filters in the analysis filter banks 900, the scaled versions of the output signals (921 FIG. 8 and 846 FIG. 7) are substantially the same and the lowpass residual signal 1506 (FIG. 14) is reduced to a quantization error. We can then simply skip the texture coding of the residual signal over the lowpass subband region LL 310, 315 in FIG. 18 if the average scaled distortion from the next lower layers (the two lower layers in the example of FIG. 18) is near or below the optimal distortion level for the assigned bitrate or quantization parameters at the current enhancement layer. The critical sampling feature of subband/wavelet coding is thus retained for achieving best compression efficiency and reduced complexity overhead. Nevertheless, unlike the conventional subband/wavelet image coding system, the proposed intra-frame scalable coding embodiment, similar to pyramidal coding, still possesses the freedom for designing the optimal down sampling filter at the encoder to generate the desirable source video of the reduced resolution for target applications. The resulting difference 1506 (FIG. 14) between the original low-pass subband signal 846 (FIG. 8) and the scaled base-layer frame 921 (FIG. 8) can be compensated by the coded lowpass subband residual signal 310, 315 (FIG. 18).

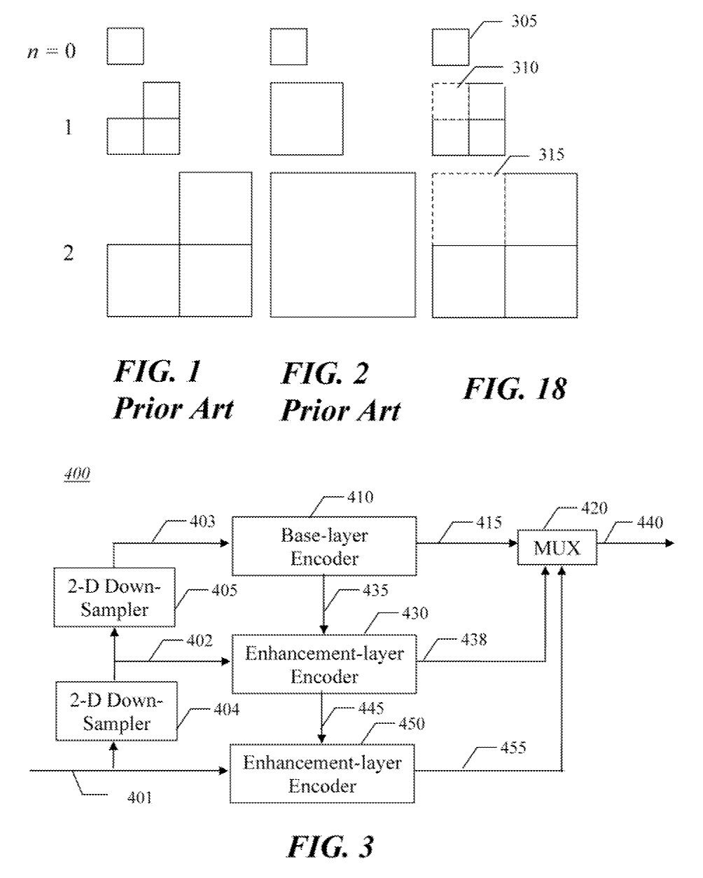

FIG. 18 can be compared with FIGS. 1 and 2 to observe differences between the coded signals employed by pyramidal coding, subband/wavelet coding, and the proposed scalable coding approach, respectively. FIG. 18 illustrates that the difference between the original low-pass subband signal and the scaled base-layer frame can be compensated by the coded lowpass subband residual signal. The residual coding of the lowpass subbands, as indicated by the dashed regions in the figure, is only optional in the proposed embodiments. The residual coding of the lowpass subbands can be utilized to further reduce the quantization error fed back from the lower layer. The residual coding of the lowpass subbands can be utilized to compensate for difference between the original low-pass subband signal 846 (FIG. 8) and the scaled base-layer frame 921 (FIG. 8) caused by a filter difference between the down sample filter that generates the lower resolution version of the source frame and the low pass analysis filter that generates the subband representation of the current enhancement layer.

In some embodiments, the creation of the versions of the source video frame other than the version of the source video frame having the highest resolution is done by starting with the highest resolution version of the source video frame and recursively creating each next lower resolution source video frame from a current version by performing a cascaded two-dimensional (2-D) separable filtering and down-sampling operation in which a one-dimensional lowpass filter is associated with each version and at least one downsampling filter is different from a lowpass filter of the subband analysis filter banks that generates subband representations for a resolution version of the source frame that is next higher than the lowest resolution. In these embodiments the residual coding of the lowpass subband can be utilized, as described above, to compensate for difference between the original low-pass subband signal 846 (FIG. 7) and the scaled base-layer frame 921 (FIG. 8).

Certain of the methods described above with reference to FIGS. 3-18 have been fully implemented using the JVT JSVM reference software version JSVM 6_{—}8_{—}1. The Intra coding test condition in defined by the JVT core experiment (CE) on inter-layer texture prediction for spatial scalability was adopted for evaluation of the proposed algorithm. The four test sequences BUS, FOOTBALL, FOREMAN, and MOBILE are encoded at a variety of base and enhancement layer QP (quantization parameter) combinations. The CE benchmark results were provided by the CE coordinator using the reference software JSVM 6_{—}3.

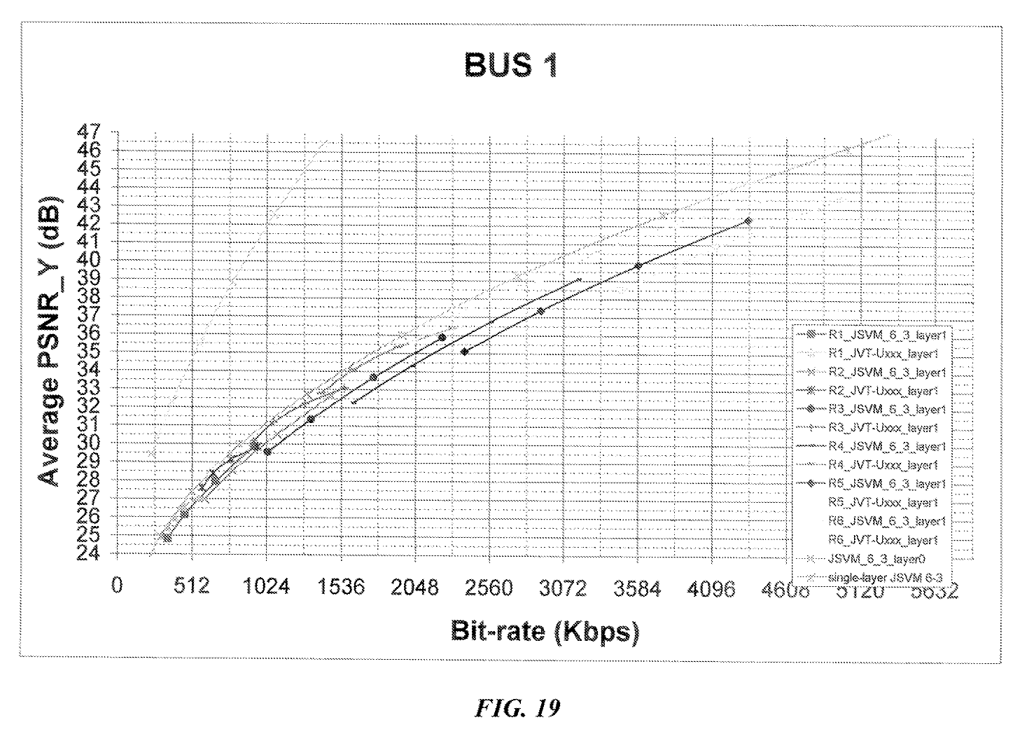

For test results indicated by JVT-Uxxx in FIG. 19, the Daub. 9/7 filters were used for wavelet analysis/synthesis (the same floating wavelet filters adopted by JPEG 2000) of the higher layer frames. The encoder employed the same lowpass filter for dyadic downsampling the input intra-frame. The coding of the entire lowpass subband was skipped. Each curve segment displays the results encoded by the same base QP and four different enhancement QP values. The second test point in each segment happens to correspond to the optimal base and enhancement QP combination in a rate-distortion sense for the given base layer QP. As one can see, the proposed algorithm significantly outperformed the related JSVM results when the enhancement coding rate was not far from the optimal operation point.

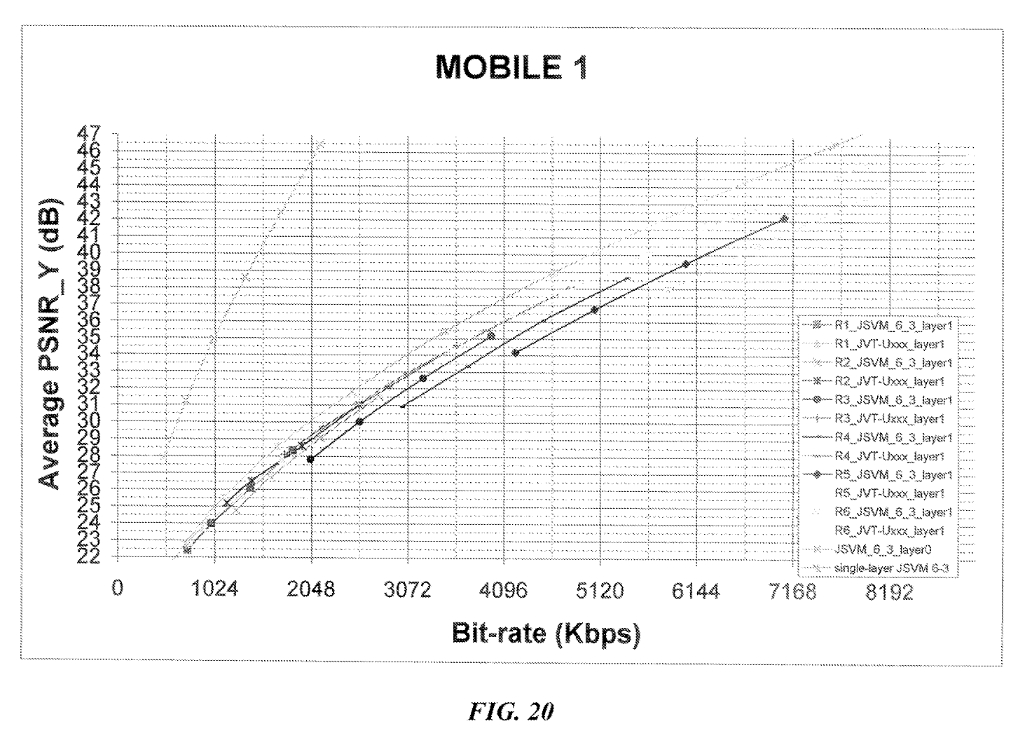

For generating the test results in FIG. 20 the same filter banks settings were used as in the previous experiment but the lowpass subband was encoded for further refinement and correction of lowpass signal. As one can see, the proposed method provided a smooth rate-distortion curve and consistently outperformed the related JSVM results. Most importantly, the resulting enhancement coding performance did not vary much with the base QP value, in a clear contrast to the corresponding JSVM results.

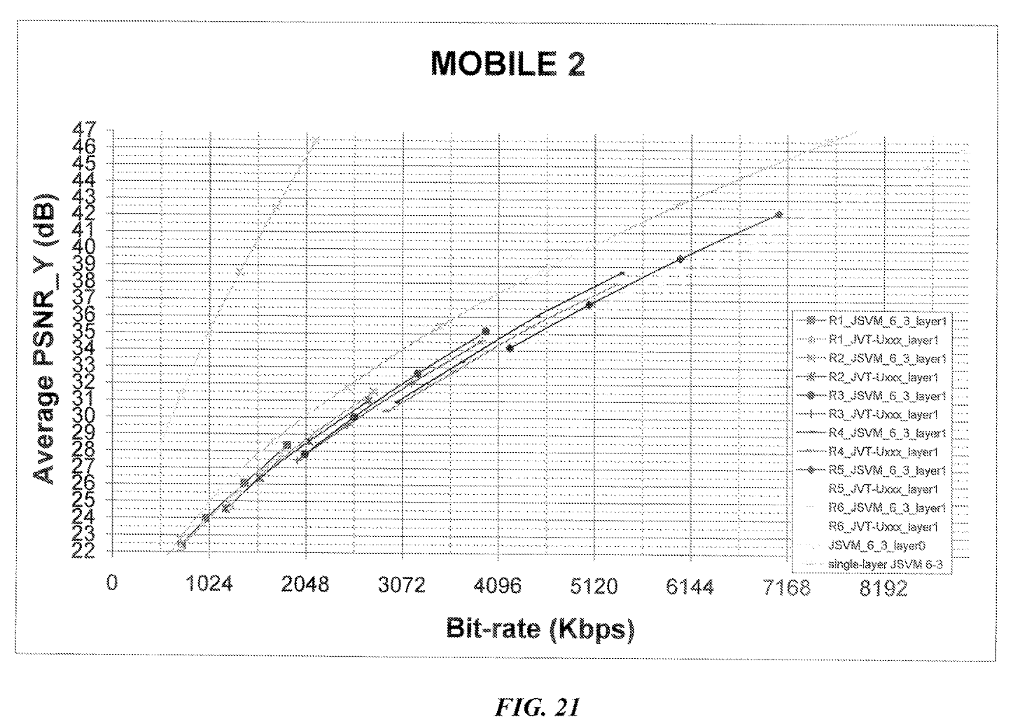

For the test results in FIG. 21, the AVC lowpass filter was employed for generating the low resolution video and coding of the lowpass band image region was not skipped. As one can see the results are almost as good as the related JSVM results. The performance degradation against the related results in FIG. 5 is considered reasonable because the AVC downsampling filter and the lowpass subband filter have very different frequency response characteristics.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. As such, these functions may be interpreted as steps of a method to perform video compression and decompression. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A spatial scalable video encoding method for compressing a source video frame, comprising:
receiving versions of a source video frame, each version having a unique resolution;
generating a base layer bitstream by encoding a version of the source video frame having the lowest resolution;
generating a set of enhancement layer bitstreams, wherein each enhancement layer bitstream in the set is generated by encoding a corresponding one of the versions of the source video frame, the encoding comprising for each version of the source video frame
decomposing the corresponding one of the versions of the source video frame by subband analysis filter banks into a subband representation of the corresponding one of the versions of the source video frame;
forming an inter-layer prediction signal which is a representation of a recovered source video frame at a next lower resolution; and
generating the enhancement layer bitstream by encoding the subband representation by an inter-layer frame texture encoder that uses the inter-layer prediction signal; and
composing a scalable bitstream from the base layer bitstream and the set of enhancement layer bitstreams using a bitstream multiplexer.

2. The method according to claim 1, wherein the inter-layer prediction signal is a scaled subband domain representation of the recovered source video frame at a next lower resolution.

3. The method according to claim 1, wherein the inter-layer prediction signal is a scaled pixel domain representation of the recovered source video frame at a next lower resolution.

4. The method according to claim 1, further comprising creating the versions of the source video frame other than the version of the source video frame having the highest resolution by starting with the highest resolution version of the source video frame and recursively creating each next lower resolution source video frame from a current version by performing a cascaded two-dimensional (2-D) separable filtering and down-sampling operation using a one-dimensional lowpass filter associated with each version, wherein at least one lowpass filter employed for down sampling is different from the lowpass filter of the subband analysis banks that are employed to generate a subband representation of a current resolution version of the source frame.

5. The method according to claim 1, wherein the method is used for compressing an image instead of a video frame.

6. The method according to claim 1, wherein the filters in the subband analysis filter banks belong to one of a family of wavelet filters and a family of QMF filters.

7. The method according to claim 1, wherein the inter-layer frame texture encoder comprises a block transform encoder.

8. The method according to claim 7, wherein the subband representation is sequentially partitioned into a plurality of block subband representations for non-overlapped blocks, further comprising encoding the block subband representation for each non-overlapped block by the inter-layer frame texture encoder and encoding the block subband representation further comprises:
forming a spatial prediction signal from recovered neighboring subband coefficients;
selecting a prediction signal between the inter-layer prediction signal and the spatial prediction signal for each block adaptively; and
encoding, by the transform block encoder, a prediction error signal that is a difference of the block subband representation and the selected prediction signal for each block.

9. The method according to claim 7, wherein the inter-layer frame texture encoder comprises an enhancement-layer intraframe coder defined in Amendment 3 (Scalable Video Extension) of the MPEG-4 Part 10 AVC/H.264 standard and the macro-block modes are selected to be I_BL for all macro-blocks.

10. The method according to claim 1, wherein the inter-layer frame texture encoder comprises an intra-layer frame texture encoder that encodes a residual signal that is a difference between the subband representation and the inter-layer prediction signal.

11. The method according to claim 1, wherein the encoding of the subband representation is performed only for the high frequency subbands of the corresponding one of the versions of the source video frame.

12. The method according to claim 1, wherein the enhancement-layer bitstreams contain a syntax element indicating the number of the decomposition levels of each enhancement layer.

13. A spatial scalable video decoding method for decompressing a coded video frame into a decoded video frame, comprising:
extracting a base layer bitstream and a set of enhancement layer bitstreams from a scalable bitstream using a bitstream de-multiplexer;
recovering a lowest resolution version of the decoded video frame from the base layer bitstream;
recovering a set of decoded subband representations, wherein each decoded subband representation in the set is recovered by decoding a corresponding one of the set of enhancement layer bitstreams, comprising for each enhancement layer bitstream
forming an inter-layer prediction signal which is a representation of a recovered decoded video frame at a next lower resolution, and
recovering the subband representation by decoding the enhancement layer by an inter-layer frame texture decoder that uses the inter-layer prediction signal; and
synthesizing the decoded video frame from the decoded subband representation at the final enhancement layer using subband synthesis filter banks; and
performing a clipping operation on the synthesized video frame according to the pixel value range.

14. The method according to claim 13, wherein the inter-layer prediction signal is a scaled subband domain representation of the recovered source video frame at the next lower resolution.

15. The method according to claim 13, wherein the inter-layer prediction signal is a scaled pixel domain representation of the recovered source video frame at the next lower resolution.

16. The method according to claim 13, wherein the method is used for decompressing a compressed image instead of an encoded video frame.

17. The method according to claim 13, wherein the filters in the subband synthesis filter banks belong to one of a family of wavelet filters and a family of QMF filters.

18. The method according to claim 13, wherein the inter-layer frame texture decoder comprises a block transform decoder.

19. The method according to claim 18, wherein the decoded subband representation is sequentially partitioned into a plurality of decoded block subbands for non-overlapped blocks, further comprising generating the decoded block subband representation for each non-overlapped block by the inter-layer frame texture decoder and generating the decoded block subband representation further comprises:
forming a spatial prediction signal from recovered neighboring subband coefficients;
selecting a prediction signal between the inter-layer prediction signal and the spatial prediction signal for each block adaptively; and
decoding, by the transform block decoder, a prediction error signal that is a difference of the decoded block subband representation and the selected prediction signal for each block.

20. The method according to claim 18 wherein the inter-layer frame texture decoder comprises an enhancement layer intra-frame decoder defined in Amendment 3 (Scalable Video Extension) of the MPEG-4 Part 10 AVC/H.264 standard.

21. The method according to claim 18, wherein the set of enhancement layer bitstreams is compatible with Amendment 3 (Scalable Video Extension) of the MPEG-4 Part 10 AVC/H.264 standard.

22. The method according to claim 18, wherein the inter-layer frame texture decoder comprises an enhancement layer intra-frame decoder described in one of the standards MPEG-2, MPEG-4, and the version.2 of H.263 but without a clipping operation performed on the decoded signal in the intra-frame decoder.

23. The method according to claim 13, wherein the inter-layer texture decoder comprises an intra-layer texture decoder that generates a residual signal from an enhancement layer and wherein the subband representation is generated by adding the inter-layer prediction signal to the residual signal

24. A spatial scalable encoding system for compressing a source video frame, comprising:
a plurality of down-samplers, each for generating a version of a source video frame having a unique resolution;
a base layer encoder for generating a base layer bitstream by encoding a version of the source video frame having the lowest resolution;
an enhancement layer encoder for generating a set of enhancement layer bitstreams, wherein each enhancement layer bitstream in the set is generated by encoding a corresponding one of the versions of the source video frame, the enhancement layer encoder comprising
subband analysis filter banks for decomposing the corresponding one of the versions of the source video frame by subband analysis filter banks into a subband representation of the corresponding one of the versions of the source video frame, and
an inter-layer frame texture encoder for generating the enhancement layer bitstream by encoding the subband representation using an inter-layer prediction signal, the inter-layer frame texture encoder further comprising an inter-layer predictor for forming the inter-layer prediction signal which is a representation of a recovered source video frame at a next lower resolution; and
a bitstream multiplexer for composing a scalable bitstream from the said base layer bitstream and enhancement layer bitstreams.

25. An intra-frame spatial scalable decoding system for decompressing a coded video frame from a scalable bitstream, comprising:
a bitstream de-multiplexer for extracting a base layer bitstream and a set of enhancement layer bitstreams from a scalable bitstream
a base layer decoder for decoding a lowest resolution version of the coded video from the base layer bitstream;
an enhancement layer decoder for recovering a set of decoded subband representations, wherein each decoded subband representation in the set is recovered by decoding a corresponding one of the set of enhancement layer bitstreams, the enhancement layer decoder comprising an inter-layer frame texture decoder for decoding a subband representation at each enhancement layer, the inter-layer frame texture decoder comprising
an inter-layer predictor for forming an inter-layer prediction signal from a temporally concurrent recovered video frame at the next lower enhancement layer, and
a block transform decoder for decoding texture information; and
synthesis filter banks for synthesizing the decoded frame from the decoded subband representation at the highest enhancement layer; and
a delimiter that performs a clipping operation on the synthesized video frame according to the pixel value range.
